(19) United States
(12) Patent Application Publication
(10) Pub. No.: US 2023/0143480 A1
(43) Pub. Date: May 11, 2023

(54) TREE INJECTION ASSEMBLY AND METHOD

(71) Applicant: Thomas D. Johnson, Buffalo, SD (US)

(72) Inventor: Thomas D. Johnson, Buffalo, SD (US)

(21) Appl. No.: 17/516,261

(22) Filed: Nov. 1, 2021

(51) Int. Cl. A01G 7/06

(52) U.S. Cl. CPC A01G 7/06

(57) ABSTRACT

A tree injection assembly and method includes fluidly coupling a source of pressurized liquid to a chamber. The chamber is comprised of a resiliently elastic perimeter wall and the chamber is inflated with a predetermined amount of the pressurized liquid. After being the chamber is inflated with the pressurized liquid, the perimeter wall exerts pressure on the pressurized liquid. An injection nozzle, fluidly coupled to the chamber with a conduit, is inserted into a borehole formed in a tree. The chamber is allowed to deflate to force the liquid into the tree through the borehole.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING METHOD.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to tree injection device and more particularly pertains to a new tree injection device for injecting liquids into a tree. Such liquids typically include insecticides, fungicides, growth regulators, nutrients, fertilizers and the like. The liquid is injected through a borehole formed in a tree to deliver the liquid to the sapwood of a tree trunk.

### Description of Related Art Including Information Disclosed Under 37 CFR 1.97 And 1.98

The prior art relates to tree injection devices that have comprised either direct, pressurized injection such as with an injection gun, or by way of gravity feeders wherein a container of liquid is suspended above and fluidly coupled to a borehole. Each of these methods have their downsides. Utilizing pumps or injection guns to directly inject the fluid into a tree involves costly equipment as well as prevents the ability to deliver a dosage of liquid over an extended period such as between a few hours and up to three days. Gravity type delivery systems require additional work to secure the container above the borehole and flow can be impeded by the tree sealing the borehole and back-pressure from the sapwood. Thus a need exists to overcome the tree’s resistance to receiving the liquid in an inexpensive manner while allowing for the elongation of dosage delivery times.

### BRIEF SUMMARY OF THE INVENTION

An embodiment of the disclosure meets the needs presented above by generally comprising a conduit that has a first end and a second end. The conduit is configured to allow liquid to flow into the first end and outwardly of the second end. An injection nozzle is fluidly coupled to the second end and tip is extendable into a tree to allow liquid from the conduit to flow through the injection nozzle and into the tree. A chamber is fluidly coupled to the first end of the conduit. The chamber has a perimeter wall bounding an interior of the chamber and an opening in the perimeter wall is fluidly coupled to the first end. The chamber is comprised of resiliently elastic material. The chamber is inflated with liquid when the liquid is pressurized externally of the chamber and delivered into the chamber through the conduit. The perimeter wall of the chamber exerts pressure on the liquid such that the liquid is ejected into the first end and outwardly of the second end of the conduit.

In another embodiment of the disclosure, a method of injecting liquid into a borehole of a tree includes fluidly coupling a source of pressurized liquid to a chamber. The chamber is comprised of a resiliently elastic perimeter wall and the chamber is inflated with a predetermined amount of the pressurized liquid. After being the chamber is inflated with the pressurized liquid, the perimeter wall exerts pressure on the pressurized liquid to retain it in a pressurized condition. An injection nozzle, fluidly coupled to the chamber with a conduit, is inserted into a borehole formed in a tree. The chamber is allowed to deflate to force the liquid into the tree through the borehole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a rear and side isometric view of a tree injection assembly and method according to an embodiment of the disclosure.

FIG. 2 is a side isometric view of an embodiment of the disclosure.

FIG. 3 is a side and top isometric view of an embodiment of the disclosure.

FIG. 4 is a broken cross-sectional view of an embodiment of the disclosure taken along line 4-4 of FIG. 1.

FIG. 5 is a cross-sectional view of a chamber of an embodiment of the disclosure.

FIG. 6 is an isometric in-use view of an embodiment of the disclosure.

FIG. 7 is a side in-use view of an embodiment of the disclosure.

### DETAILED DESCRIPTION OF THE INVENTION

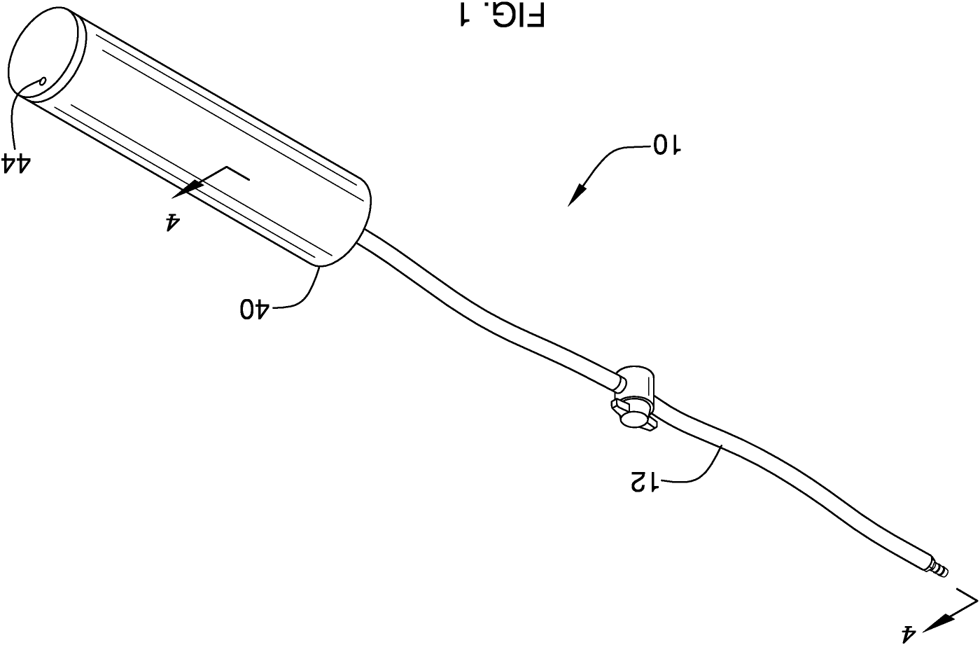

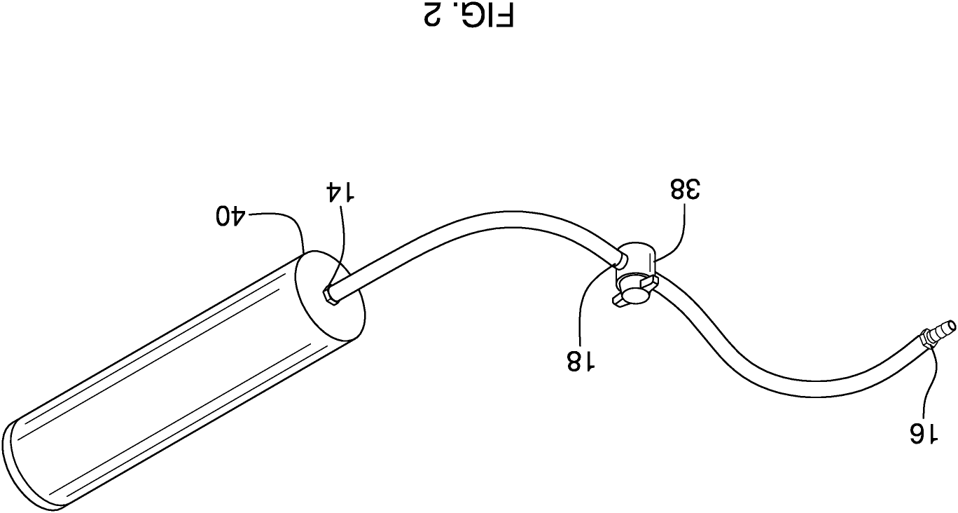

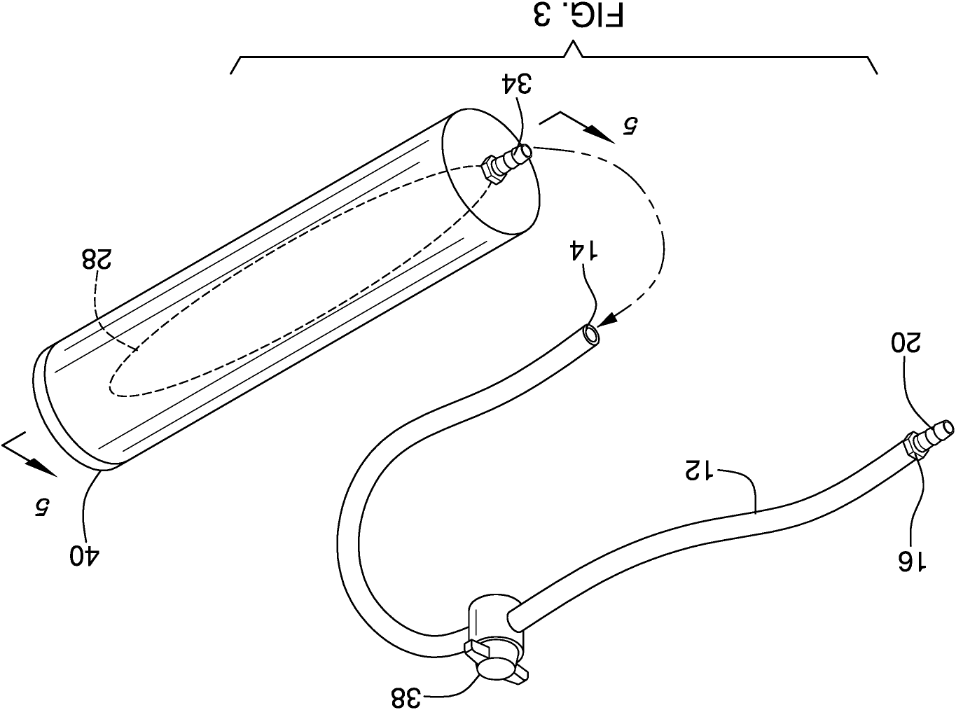

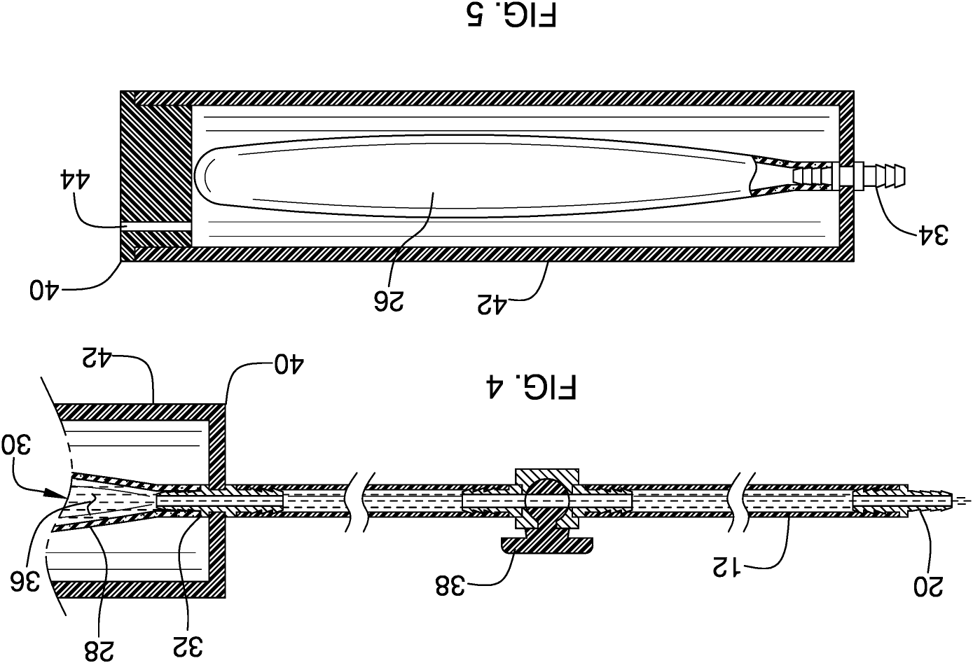

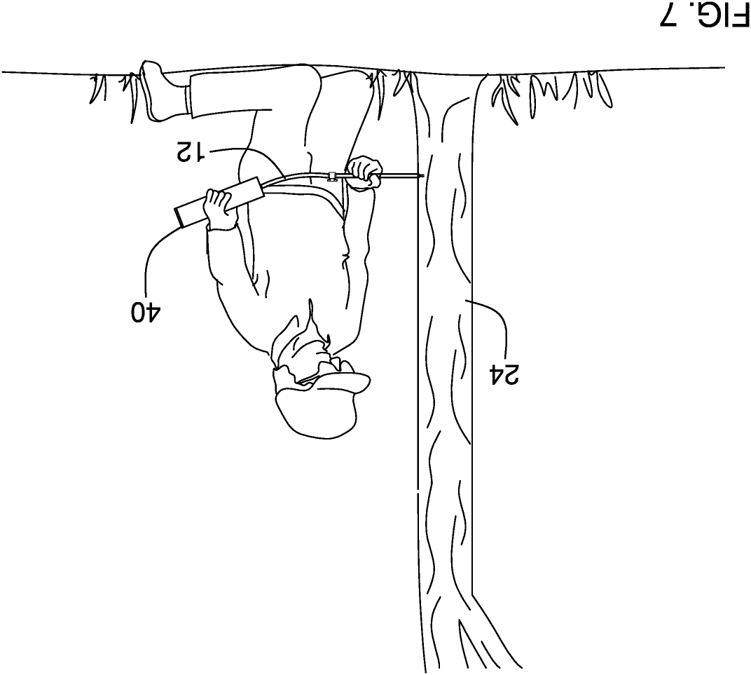

With reference now to the drawings, and in particular to FIGS. 1 through 7 thereof, a new tree injection device embodying the principles and concepts of an embodiment of the disclosure and generally designated by the reference numeral 10 will be described.

As best illustrated in FIGS. 1 through 7, the tree injection assembly 10 and method generally comprises a conduit 12 that has a first end 14 and a second end 16. The conduit 12 is configured to allow liquid to flow into the first end 14 and outwardly of the second end 16. The conduit 12 will typically comprise a flexible hose and may include plastic and elastomeric materials. Conventional irrigation tubing may be utilized due to its affordability and suitability for use with the method taught herein. The length of the conduit 12 is not material to the functionality of the method 10 but will typically be between about 12 inches and 3 feet in length. As can be seen in the Figures, the conduit 12 may have a break 18 therein for reasons that will be explained below.

An injection nozzle 20 is fluidly coupled to the second end 16. The injection nozzle 20 is extendable into a borehole 22 of a tree 24 to allow liquid from the conduit 12 to flow through the injection nozzle 20 and into the tree 24. Typically, the injection nozzle 20 is barbed and is frictionally engageable with a tree to prevent unintended removal from the tree 24. A barbed nozzle further provides an advantage of creating a sealed juncture to prevent fluid from leaking around the nozzle 20. A conventional ¼ inch to 3/16 inch barbed reducer may be utilized for the injector tip. If the borehole 22 is filled with a plug, it is also conceivable that the injection nozzle 20 be a needle which is extendable through the plug.

A chamber 26 is fluidly coupled to the first end 14 of the conduit 12 for receiving liquid from and delivering liquid into the conduit 12. The chamber 26 has a perimeter wall 28 bounding an interior 30 of the chamber 26 and an opening 32 in the perimeter wall 28 is fluidly coupled to the first end 14 and this may be achieves, as an example, with a barbed reducer 34. The chamber 26 is comprised of resiliently elastic material such as natural or synthetic rubber and may be in the form of a cylindrical tube before inflation. When the chamber 26 is inflated with liquid 36 under pressure from an external source through the conduit 12, the perimeter wall 28 of the chamber 26 will exert force to on the liquid 36 positioned within the chamber 26 such that the liquid 36 is retained under pressure such that it is ejected into the first end 14 and outwardly of the second end 16 of the conduit 12. For simplicity, the term “pressurized liquid” herein is intended to define liquids that are under pressure greater than standard atmospheric pressure for controlling their direction of flow wherein the flow is also unhindered by gravity. While the chamber 26 is fillable through the conduit, it should be understood that the chamber 26 may include a separate fill aperture for receiving pressurized liquid.

A valve 38 is positioned between the first 14 and second 16 ends and is in fluid communication with the conduit 12. As can be seen in the Figures, the conduit 12 may include the break 18 to allow two sections of the conduit 12 to each engage the valve 38. However, the valve 38 may alternatively be positioned in the conduit 12. The valve 38 is positionable in a closed position restricting liquid 36 from flowing through the conduit 12 or in an open position allowing liquid 36 to flow through the conduit 12.

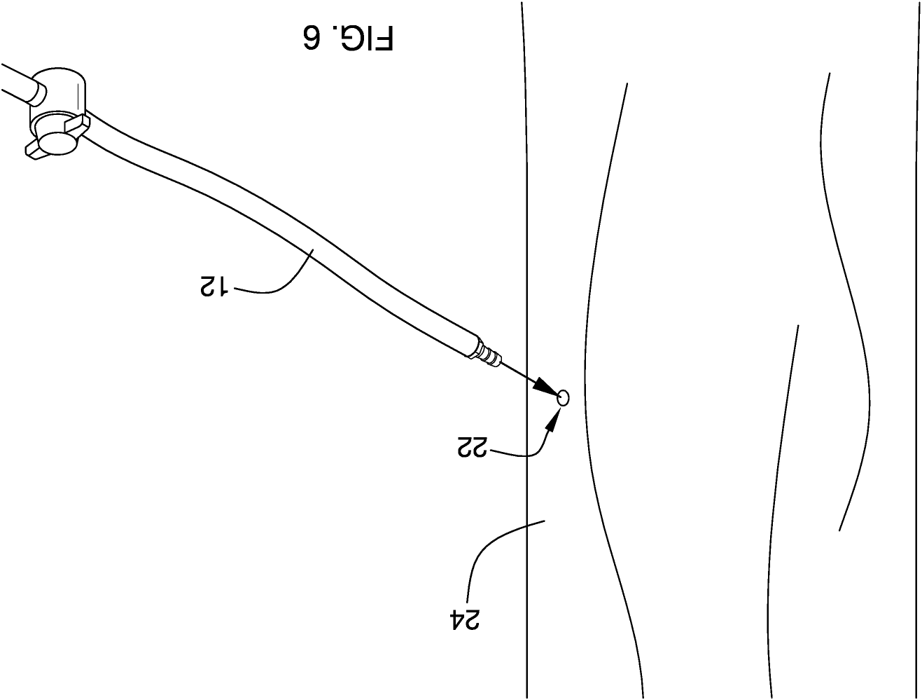

An encapsulating member 40 is positioned around and contains the chamber 26 wherein the encapsulating member 40 has an outer wall 42 extending around the chamber 26. The outer wall 42 is less elastic than the chamber 26 for the purpose of inhibiting over inflation of the chamber 26. When the chamber 26 is not fully inflated, as shown in FIG. 5, empty space between the chamber 26 and the encapsulating member 40 allows for additional filling of the chamber 26. FIG. 1 depicts a cylindrical housing being used as the encapsulating member 40, though it should be understood that any containment assembly, having sufficient rigidity to prevent over inflation of the chamber 26, may be utilized. Thus, where the conduit 12 may be comprised of ¼ inch irrigation tube, the encapsulating member 40 may comprise a 1.5 inch irrigation tube having the chamber positioned therein. The encapsulating member 40 will typically include an air opening 44 in the encapsulating member 40 to allow for air passage as the chamber 26 inflates and deflates.

In use, a conventional mechanical pump is fluidly coupled to the conduit 12 to inject into the conduit 12 a predetermined amount of a selected liquid 36. The liquid 36, being under pressure by the pump, will overcome the back pressure caused by the chamber 26 such that the chamber 26 begins to inflate. Once the predetermined amount of liquid 36 has been delivered, the valve 38 is moved to a closed position to retain the liquid 36, now under pressure from the chamber 26, within the chamber 26 and in the conduit between the valve 38 and the chamber 26. The predetermined amount can vary greatly based on factors such as the dosage concentration and size of the tree receiving the liquid 36 and is typically between 5 ml and 150 ml. Once the chamber 26 has been filled, the injection nozzle 20 is inserted into the borehole 22 a sufficient distance such that the liquid 36 will enter the sapwood of the tree 24. The valve 38 is then opened to allow the liquid 36 to leave the chamber 26 and enter the tree 24.

Because the liquid 36 is being driven under pressure exerted by the perimeter wall 28 of the chamber 26, the liquid 36 will continually flow by overcoming back-pressure from liquid 36 buildup in the tree 24 and by preventing the sealing of the borehole 22. Additionally, unlike gravity fed methods, the liquid holding vessel, in this case the chamber 26, need not be attached to the tree 24 such that the liquid 36 is positioned above the borehole 22 as the liquid 36 is forced out of the conduit through pressure regardless of the position of the chamber. It should also be understood that because the chamber 26 volume can be adjusted as the tree grows, only a single a borehole 22 need to be drilled per growing seasons whereas pre-loaded devices require multiple drill holes which, over time, can contribute to physical damage to the tree 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tree injection assembly configured for injecting a liquid into a tree, said assembly comprising:
a conduit having a first end and a second end, said conduit being configured to allow liquid to flow into said first end and outwardly of said second end;
an injection nozzle being fluidly coupled to said second end, said injection nozzle being extendable into the tree to allow liquid from the conduit to flow through the injection nozzle and into the tree; and
a chamber being fluidly coupled to said first end of said conduit, said chamber having a perimeter wall bounding an interior of said chamber, an opening in said perimeter wall being fluidly coupled to said first end, said chamber being comprised of resiliently elastic material, wherein said chamber is inflated with liquid when the liquid is pressurized externally of said chamber and delivered into said chamber through said conduit, said perimeter wall of said chamber being configured to exert pressure on the liquid when positioned within said chamber such that the liquid is ejected into said first end and outwardly of said second end of said conduit.

2. The tree injection assembly according to claim 1, further including a valve being positioned between said first and second ends and being in fluid communication with said conduit to control flow of liquid through said conduit.

3. The tree injection assembly according to claim 2, wherein said valve is positionable in a closed position restricting liquid from flowing through said conduit or in an open position allowing liquid to flow through said conduit.

4. The tree injection assembly according to claim 1, further including an encapsulating member being positioned around and containing said chamber, said encapsulating member having an outer wall extending around said chamber, said outer wall being less elastic than said chamber and inhibiting over inflation of said chamber.

5. The tree injection assembly according to claim 1, wherein said conduit comprises a flexible hose.

6. The tree injection assembly according to claim 1, wherein said injection nozzle is barbed and being frictionally engageable with a tree to prevent unintended removal from the tree.

7. The tree injection assembly according to claim 1, wherein said chamber comprises an elastomeric tubing.

8. The tree injection assembly according to claim 7, wherein said elastomeric tubing comprises a natural or synthetic rubber material.

9. The tree injection assembly according to claim 2, further including an encapsulating member being positioned around and containing said chamber, said encapsulating member having an outer wall extending around said chamber, said outer wall being less elastic than said chamber and inhibiting over inflation of said chamber.

10. The tree injection assembly according to claim 9, wherein said valve is positionable in a closed position restricting liquid from flowing through said conduit or in an open position allowing liquid to flow through said conduit.

11. A method of injecting liquid into a tree comprising the steps of:
fluidly coupling a pressurized liquid to a chamber, the chamber being comprised of a resiliently elastic perimeter wall;
inflating the chamber with pressurized liquid with a predetermined amount of the liquid, wherein the perimeter wall exerts pressure on the liquid;
inserting an injection nozzle into a borehole formed in a tree, the injection nozzle being fluidly coupled to the chamber with a conduit; and
allowing the chamber to deflate and force the liquid into the tree through the borehole.

12. The method of injecting liquid into a tree according to claim 11, further including the steps of:
opening a valve in fluid communication with the conduit before inflating the chamber to allow the pressurized liquid to enter the chamber and then closing the valve after the chamber has been inflated with pressurized liquid; and
opening the valve after the injection nozzle has been inserted into the borehole.

13. The method of injecting liquid into a tree according to claim 12, wherein the step of inflating the chamber further includes the step of having an encapsulating member being positioned around and containing said chamber to inhibit over inflation of said chamber.

14. The method of injecting liquid into a tree according to claim 11, wherein the step of inflating the chamber further includes the step of having an encapsulating member being positioned around and containing said chamber to inhibit over inflation of said chamber.
